(19) United States
(12) Patent Application Publication
(10) Pub. No.: US 2003/0044563 A1
(43) Pub. Date: Mar. 6, 2003

(54) Waterproof seam sealing tape

(76) Inventors: James A. Kocinec, Lexington, VA (US); Richard S. Simonson, Rustburg, VA (US)

Correspondence Address: Nixon & Vanderhye, 1100 N Glebe Rd 8th Floor, Arlington, VA, 22201, US

(21) Appl. No.: 09/506,401

(22) Filed: Feb. 18, 2000

(51) Int. Cl. B32B 3/26; B32B 3/00; B32B 27/14; B32B 7/12; B32B 15/04

(52) U.S. Cl. 428/63; 428/354; 428/346

(57) ABSTRACT

A garment sealing tape or patch may be used to waterproof seams of or repair discontinuities in a wide variety of garments or other products, such as surgeon's gowns and firefighter's turnout coats, in a simple, inexpensive and long lasting manner with minimal smoke emission. The garment sealing tape or patch may include a first layer of a dimensionally stable heat reflecting film such as a polyurethane microporous film, and a second layer bonded to the first layer. The second layer is an uncured thermosetting polyurethane or polyester adhesive having a thickness between about 0.5-12 mils. The tape or patch may also comprise a third layer which is a fabric (such as a polyester tricot having a weight between about 0.7-2.5 ounces per square yard) adhesively bonded (e.g. by hot melt adhesive) to the heat reflecting surface of the film. The tape or patch may be applied by a laundry press or iron, or using an autoclave, to apply heat sufficient to thermoset the adhesive. The tape or patch may be constructed by applying an adhesive to a first surface of the film, mating the adhesive on the film with the fabric, pressing the mated film and fabric together to adhesively secure the film to the fabric, applying the seam sealing adhesive to a second surface of the film, and slitting or cutting the resulting laminate to produce a fabric tape ribbons or fabric repair patches.

### BACKGROUND AND SUMMARY OF THE INVENTION

In the manufacture of a wide variety of garments, such as surgeon's gowns, some articles of outerwear, firefighter's turnout jackets, and garments used in the military or industries where chemical and/or heat resistance are required, and in the repair of such garments, seam sealing tape is often utilized. Most conventional seam sealing tapes have a number of disadvantages associated therewith. Typically such prior art tapes are expensive, yet do not function adequately in many environments. For example for most hospitals, garments must maintain integrity through 100 autoclave cycles (including industrial washing and drying), and conventional seam sealing tapes often do not achieve that performance standard. Also, conventional seam sealing tapes emit excessive smoke during original manufacture or autoclaving, which is aesthetically unpleasing and dirty, and potentially dangerous. For example one conventional prior art seam sealing tape utilizes polytetrafluoroethylene heat reflecting film to which a layer of thermoplastic hot melt adhesive is applied, the hot melt adhesive covering the seam of a garment. This construction is very expensive yet does not meet the required performance standard for some requirements, and emits significant amounts of smoke during autoclaving.

According to the present invention a garment sealing tape or patch, a method of making a garment tape or patch, and a method of sealing a seam of or patching a garment using a garment patch or tape (as well as the garment so produced) are provided that have numerous advantages over conventional constructions. The garment sealing tape or patch according to the invention is less expensive than conventional products, is capable of maintaining integrity through 100 autoclave cycles, and utilizes an adhesive which is cross-linked and has fewer volatile components. This results in a stable molecular distribution which benefits the user by providing low smoke evolution and improved thermal stability. The products and methods according to the invention are also highly versatile and can be used in a wide variety of manufacturing and repair procedures for a wide variety of garments and other fabric items including, without limitation, surgeon's gowns, outerwear waterproof garments, firefighter's turnout jackets, table covers, mayo stand covers, and garments requiring chemical and/or heat resistance. The methods of manufacture are practiced using conventional equipment, and the methods of utilization may be practiced using conventional laundry presses or irons, which are commonly available (for example in hospital laundries), or may be utilized in original manufacture or repair circumstances in autoclaves.

According to one aspect of the present invention a fabric sealing tape or patch is provided comprising: A first layer comprising a dimensionally stable heat reflecting film. And, a second layer bonded to the first layer and comprising an uncured thermosetting polyurethane or polyester adhesive having a thickness between about 0.5 to 12 mils. The first and second layers in completed fabric product seam-sealing tape or patch form.

For example the first layer may comprise a heat reflecting surface, and the tape or patch may further comprise a third layer comprising a fabric adhesively bonded to the heat reflecting surface, for example with a discontinuous application of a hot melt reactive polyurethane adhesive. The first layer preferably comprises a film consisting essentially of polyurethane, silicone, or vinyl, there being no reason or need to use the much more expensive polytetrafluoroethylene films often utilized in the prior art. For example the film may comprise a polyurethane microporous film having a thickness of between about 25-60 microns, e.g. between about 30-55 microns.

The second layer may comprise a linear saturated polyester film including blocked isocyanate that sets at a temperature between about 270 to 400 degrees F.

The fabric of the third layer may be knit (e.g. a tricot), or woven, and may be made from a wide variety of different fibers including polyester, and fire resistant fibers such as aramid fibers (like NOMEX® by DuPont). For example the third layer can have a weight between about 0.5 to 2.5 ounces per square yard and may comprise a polyester tricot. Alternatively when woven garments are being produced or repaired a patch or tape according to the invention may have as the fabric one having the same basic construction (e.g. a simple weave) and color as the garment to which it is to be applied.

According to another aspect of the present invention a method of making a fabric tape or patch is provided comprising: (a) Applying an adhesive to a first surface of a dimensionally stable heat reflective film. (b) Mating the adhesive on the film with a fabric. (c) Pressing the mated film and fabric together to adhesively secure the film to the fabric. (d) Applying an uncured thermosetting polyurethane or polyester adhesive having a thickness between about 0.5 to 12 mils to a second surface of the film, opposite the first surface to produce a laminate. And, (e) slitting or cutting the laminate from (d) to produce fabric seam sealing tape ribbons or fabric repair patches.

For example (d) may be practiced by hot calendering a web of an uncured thermosetting polyurethane or polyester adhesive having a thickness between about 0.5 to 12 mils to the second surface of the film. In the method (a) may be practiced by applying a discontinuous pattern of hot melt adhesive to a heat reflective surface of the film, and/or (a) may be practiced using a knit or woven polyester fabric having a weight of between about 0.7 to 2.5 oz./sq. yd., and/or (a) may be practiced using a film consisting essentially of polyurethane, silicone or vinyl. Further (c) may be practiced by passing the film and fabric through a roller nip. All of these procedures may be accomplished utilizing conventional equipment.

The invention also relates to a method of sealing a seam of or patching a garment using a garment patch or tape as described above. The method may comprise: (a) Applying the garment tape or patch to a first surface of the garment to cover a seam or discontinuity in the garment. And, (b) using a laundry press or iron, applying heat to a second surface of the garment, opposite the first surface, sufficient to thermoset the adhesive, so that the adhesive flows into the garment, but not past the film, to form a substantially waterproof bond at the seam or discontinuity. For example (a) and (b) may be practiced to repair a used surgeon's gown, to seal a seam in the manufacture of a new surgeon's gown, or to seal a seam in or repair a fire fighter's turnout jacket; and/or (b) may be practiced by subjecting the garment to a temperature of between 270-400 degrees C.

Where the garment patch or tape includes a fabric layer, then (b) may be practiced using a laundry press, iron, or autoclave, applying heat to a second surface of the garment, opposite the first surface, sufficient to thermoset the adhesive but not damage the fabric, so that the adhesive flows into the garment, but not past the film, to form an aesthetic substantially waterproof bond at the seam or discontinuity.

The invention also relates to garments made from the method as described above, which garments will have waterproof seams and patched areas. The method may be applied in new construction of garments especially for waterproofing seams, and may patch almost any discontinuity in an existing garment, such as a rip, tear, perforation, etc.

It is the primary object of the present invention to provide a simple, highly functional, cost effective, and otherwise advantageous garment sealing tape or patch, a method of manufacture thereof, a method of utilization thereof, and superior waterproofed and/or repaired garments or other final fabric products produced therefrom. This and other objects of the invention will become clear from an inspection of the detailed description of the invention and from the appended claims.

### BRIEF DESCRIPTION OF THE DRAWINGS

FIG. 1 is a box diagram indicating exemplary method steps that may be utilized in the manufacture and use of garment sealing tapes or patches according to the present invention;

FIG. 2 is a greatly enlarged schematic longitudinal cross-sectional view of an exemplary seam sealing tape or patch according to the present invention;

FIG. 3 is a detailed perspective schematic view showing a tape having the construction of FIG. 2 used for sealing a seam in a garment; and

FIG. 4 is a view like that of FIG. 3 only showing a patch according to the invention used for repairing a garment with a tear therein, the patch being cut away for clarity of illustration of the underlying tear.

### DETAILED DESCRIPTION OF THE DRAWINGS

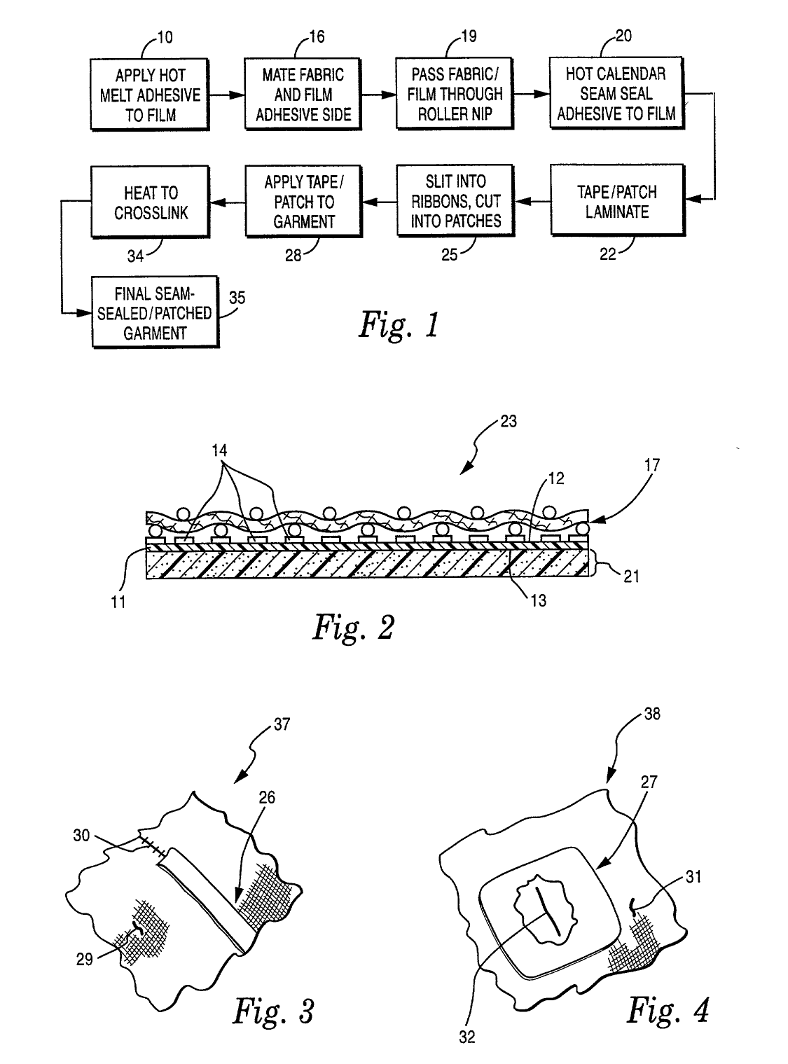

FIG. 1 schematically illustrates an exemplary method that may be practiced according to the present invention to construct an exemplary garment sealing tape or patch that can effectively waterproof a seam in a garment or other fabric product and effectively repair a discontinuity (such as a tear, cut, rip, or perforation) in a garment or other fabric product, in such a way that the tape or patch will maintain its integrity through an extended period of time, for example through 100 autoclave cycles (and associated industrial wash and dry cycles).

The first procedure illustrated schematically at 10 in FIG. 1 is to apply an adhesive to a first surface of a dimensionally stable heat reflective film. One such film is illustrated at 11 in FIG. 2, having a first surface 12 and a second surface 13 substantially opposite the first surface 12. For example the film is preferably an economical film made from a polymer, such as polyurethane, silicone, or a vinyl film. For example one such film may be Flexchem 51™ from Colorite Polymers. Another is a polyurethane microporous film available from Porvair under the trade name “Porelle Membranes” and having a thickness between about 25-60 microns, e.g. about 55 microns or about 30 microns. The film 11 first surface 12 is heat reflective, and it is to that surface that the adhesive 14 is applied.

The adhesive 14 may be selected from a wide variety of adhesives. For example the adhesive may be inherent in the film 11 itself so that the ultimate fabric (to be described) that is applied is adhered directly to the tacky surface 12 of the film 11 itself. Desirably, however, the adhesive 14 is distinct from the film 11 and comprises a hot melt adhesive, for example a hot melt reactive polyurethane adhesive, that is applied to the surface 12 by rotogravure, or a like conventional technique. The adhesive 14 preferably is applied in a discontinuous pattern, although depending upon the adhesive 14 and the film 11 it can be applied in a continuous manner. A discontinuous pattern is illustrated in FIG. 2.

The next procedure 16 in FIG. 1 is to mate the fabric, illustrated schematically at 17 in FIG. 2 and film 11. The fabric 17 is brought into face-to-face contact with the adhesive 14 of the film 11. For example both the film 11 and the fabric 17 are in web form and they are simply directed by powered and/or idling rollers into face-to-face contact with each other.

The fabric 17 may be selected from a wide variety of different fabrics, knit, woven, or in some circumstances even non-woven. Conventional weights that used will be between about 0.7 to 2.5 ounces per square yard. The weight of the fabric will depend upon the particular use and the particular construction. For example to seal a surgeon's gown seam (either in new manufacture or to repair an existing separated or a non-waterproof seam) an approximately 2.25 ounce per square yard polyester tricot (knit) fabric may be utilized. For example the polyester tricot may be made of singles, 40 denier, 30 filament. As another example, to seal an outerwear waterproof garment seam a 0.9 ounce per square yard polyester tricot would be appropriate for the fabric 17. For a fire retardant application, like a firefighter's turnout jacket, an approximately 1.8 ounce per square yard aramid tricot would be applicable (such as Nomex® fiber from DuPont).

Woven fabrics are also eminently suitable for use as the fabric 17 under many circumstances. The woven fabric would be used as the fabric 17 particularly in applications needing higher durability than can be provided by a knit fabric 17. A woven fabric 17 also could be used for patching woven garments so that the patch would not be as noticeable. For example a surgeon's gown made from a plain weave singles, 7 denier, 34 filament polyester fabric would be patched using the same color woven polyester to “blend in” with the rest of the gown. In all cases where practical, a woven fabric 17 of the same color and weave as the fabric that it is to patch would be desirable.

The next procedure 19 in the method of FIG. 1 is to press the mated film 11 and fabric 17 together to adhesively secure (e.g. with the hot melt adhesive 14) the film 11 to the fabric 17. For example this could be done by passing the mated film and fabric through a conventional roller nip. The next procedure 20 in FIG. 1 is to apply an uncured thermosetting polyurethane or polyester adhesive, such as the adhesive shown schematically at 21 in FIG. 2, to the second surface 13 of the film 11 to produce a tape/patch laminate, as illustrated schematically at 22 in FIG. 1, and shown schematically at 23 in FIG. 2.

Preferably the seam-seal adhesive 21 has a thickness between about 0.5 to 12 mils, the thickness depending upon the particular use desired. For example the optimum thickness for a medical surgeon's gown seam (double needle flat feld seam) would be about 6 mils, whereas 3 mils may be optimal for a flat seam, and one mil optimal for patches used in repairing a discontinuity in a garment away from the seam.

The preferred seam-seal adhesive 21 is preferably initially thermoplastic and develops thermoset properties when cross-linked by reactants therein. For example a blocked isocyanate is utilized to cross-link the adhesive upon application of heat. There are many commercially available blocked isocyanates along with polyurethanes or polyesters in both solvent and aqueous form that can be used to make adhesive films, such as the seam-seal adhesive 21. Typical application temperatures, which will cause cross-linking/unblocking, are between about 270-400 degrees F. One particularly suitable adhesive film utilized as the adhesive 21 is available from Bostik known as a 10-300-3/2.

This comprises a thermosetting adhesive film based on a linear saturated polyester polymer having isocyanates that becomes unblocked upon exposure to a temperature of between about 275-400 degrees F. depending upon the pressure and dwell time. One particularly advantageous way that the procedure 20 of FIG. 1 may be practiced is by using the adhesive 21 in web form and laminating it to the film/fabric construction 11/17 in a hot calendering operation using a temperature of between 200-325 degrees F. for a short period of time (e.g. about 240 degrees F. for about 15 seconds). The time and temperature is insufficient to initiate cross-linking in the adhesive 21, but a low level of pressure is highly desirable to improve the lamination, such as the utilization of a belted press, or a heat transfer print machine.

After production of the tape/patch laminate 23 of FIG. 2, as indicated at 25 in FIG. 1, the laminate 23 is slit into ribbons to produce tape, such as the tape ribbon 26 illustrated in FIG. 3, and/or is cut into patches, such as the patch 27 illustrated in FIG. 4. The procedure 25 is accomplished utilizing conventional slitting and cutting (e.g. die cutting) equipment.

The final tape 26 or patch 27 may be used in a wide variety of manners. For example as illustrated schematically at 28 in FIG. 1 the tape 26 or patch 27 may be applied to a garment, and then heat and pressure sufficient to unblock the isocyanate in the adhesive 21 applied to cause thermosetting effected. For example in the embodiment of FIG. 3 the tape 26 is applied to the garment 29, such as a surgeon's gown, over the stitched seam 30, with the adhesive 21 in contact with the seam 30. Then sufficient heat and pressure is applied (preferably to the opposite side of the garment 29 illustrated in FIG. 3 rather than to the fabric 17 part of the tape 26) to effect cross-linking of the adhesive 21. This procedure may be practiced utilizing a conventional laundry press or iron, such as are common in hospital laundry rooms, or an autoclave, often also commonly used in hospitals.

As a result of a temperature of over about 275 degrees F. applied to the adhesive 21 cross-linking occurs, and the adhesive 21 flows under heat and pressure into the fabric of the garment being sealed, waterproofing it. The film 11 prevents the seam 30 threads from passing through the adhesive layer 21 during this procedure, and also acts as a heat reflective layer increasing the thermal transfer to the adhesive 21 during the seaming operation. The fabric layer 17 adds aesthetics and abrasion resistance to the tape 26.

After sufficient heat and pressure have been applied by the laundry press or iron, a substantially waterproof bond is formed at the seam 30.

FIG. 4 shows the application of a patch 27 to a garment 31 having a discontinuity 32 (such as a tear, rip, perforation, or the like) therein. As illustrated in FIG. 4 the patch 27 is applied so that it substantially completely covers the discontinuity 32, with the adhesive 21 of the patch engaging the surface of the garment 31. Then heat to cross-link, illustrated schematically at 34 in FIG. 1 and as described above with respect to the tape 26, is applied, resulting in a final seam-sealed or patched garment, as illustrated schematically at 35 in FIG. 1.

For example the final garment 37 of FIG. 3 has the seam 30 thereof waterproofed, and the garment 38 of FIG. 4 has the discontinuity 32 therein patched. For both of the garments 37, 38 the waterproofing of the seam or patching of the discontinuity is sufficient so that the garments 37, 38 maintain their integrity (including the tape 26 and patch 27) through at least one hundred autoclave cycles, performance standard in many circumstances, as well as industrial laundering, industrial drying, and the like associated therewith. In a normal hospital autoclave situation, the garments 37, 38 are placed in a vacuum and steam is applied with a top temperature of about 275 degrees F. for four minutes.

While the method of FIG. 1 was described with respect to the preferred three layer laminate 23 of FIG. 2, it is to be understood that a two layer laminate, comprising only the film 11 and the seam seal adhesive 21, may be provided, in which case the film 11 is combined with a web of adhesive 21 in the hot calendering operation illustrated at 20 in FIG. 1 to produce a final product. The two layer (11, 21) construction is particularly suitable for use during garment manufacturing to seal seams which are required to be impervious to fluids (such as blood in a surgeon's gown). The tape 26 or patch 27 construction 23 is ideally suited to repair discontinuities in surgical gowns, back table covers, mayo stands, and the like. The tape 26 in either the two or three layer form can be used to seal seams in outerwear garments to keep them waterproof, and to seal seams in patched garments requiring chemical and/or heat resistance, such as firefighter's turnout jackets.

The seam sealed or patched garments 37, 38 according to the invention are capable of achieving the following results:

| Test | Result |
|---|---|
| ASTM D751 | no leakage at 2 psi for 5 min. |
| ISO 811 | no leakage at 10,000 mm |
| ASTM F1670 | no leakage |
| ASTM F1671 | no leakage |

The above test nomenclature means the following: ASTM D751 (Mullen Hydrostatic), ISO 811 (Hydrostatic Head), ASTM F1670 (Resistance to Synthetic Blood) and ASTM F1671 (Resistance to Blood-Borne Pathogens).

Thus it will be seen that according to the present invention an inexpensive yet highly functional and effective garment sealing tape or patch, and method of manufacture and utilization thereof, and garment so produced, are provided. When the tapes or patches are subjected to conventional autoclave, laundry press, or iron applications, only a minimum amount of smoke evolves, and the end garment has improved thermal stability compared to the prior art. The garment is capable of maintaining integrity through one hundred or more autoclave/wash/dry cycles, and the water/fluid proofness of the tape 26 and patch 27 is such that each of the tests as described above are passed.

In the above disclosure all narrow ranges within a broad range are specifically included herein. That is “270-400 degrees F.” means 271-312, 350-399, and 300-400 degrees F., and all other narrower ranges within the broad range.

While the invention has been herein shown and described in what is presently conceived to be the most practical and preferred embodiment thereof it will be apparent that many modifications may be made thereof within the scope of the invention. For example in the initial application of adhesive for the manufacture of the laminate 23, substantially the same material that forms the film 11 may be coated directly on the fabric 17, so that the heat reflecting film layer 11 actually forms after the coating operation. Other modifications are also within the scope of the invention, which scope is to be accorded the broadest interpretation of the appended claims so as to encompass all equivalent products and processes.

What is claimed is:

1. A fabric sealing tape or patch comprising:
a first layer comprising a dimensionally stable heat reflecting film; and
a second layer bonded to said first layer and comprising an uncured thermosetting polyurethane or polyester adhesive having a thickness between about 0.5 to 12 mils;
said first and second layers in final fabric product seam-sealing tape or patch form.

2. A fabric sealing tape or patch as recited in claim 1 wherein said first layer comprises a heat reflecting surface, and wherein said tape or patch further comprises a third layer comprising a fabric adhesively bonded to said heat reflecting surface.

3. A fabric sealing tape or patch as recited in claim 2 wherein said first layer comprises a film consisting essentially of polyurethane, silicone, or vinyl.

4. A fabric sealing tape or patch as recited in claim 1 wherein said first layer comprises a polyurethane microporous film having a thickness of between about 25-60 microns.

5. A fabric sealing tape or patch as recited in claim 1 wherein said second layer comprises linear saturated polyester film including blocked isocyanate that sets at a temperature between about 270 to 400 degrees F.

6. A fabric sealing tape or patch as recited in claim 2 wherein said fabric of said third layer comprises a polyester tricot. having a weight of between about 0.7 to 2.5 oz./sq, yd.

7. A fabric sealing tape or patch as recited in claim 2 wherein said fabric is knit or woven of primarily aramid fibers.

8. A fabric sealing tape or patch as recited in claim 2 wherein said fabric is adhesively bonded to said heat reflecting surface by a discontinuous pattern of hot melt adhesive.

9. A method of making a fabric tape or patch comprising:
(a) applying an adhesive to a first surface of a dimensionally stable heat reflective film;
(b) mating the adhesive on the film with a fabric;
(c) pressing the mated film and fabric together to adhesively secure the film to the fabric;
(d) applying an uncured thermosetting polyurethane or polyester adhesive having a thickness between about 0.5 to 12 mils to a second surface of the film, opposite the first surface to produce a laminate; and
(e) slitting or cutting the laminate from (d) to produce fabric sealing tape ribbons or fabric repair patches.

10. A method as recited in claim 9 wherein (d) is practiced by hot calendering a web of an uncured thermosetting polyurethane or polyester adhesive having a thickness between about 0.5 to 12 mils to the second surface of the film.

11. A method as recited in claim 9 wherein (a) is practiced by applying a discontinuous pattern of hot melt adhesive to a heat reflective surface of the film.

12. A method as recited in claim 9 wherein (a) is practiced using a knit or woven polyester fabric having a weight of between about 0.7 to 2.5 oz./sq. yd.

13. A method as recited in claim 9 wherein (c) is practiced by passing the film and fabric through a roller nip.

14. A method as recited in claim 9 wherein (a) is practiced using a film consisting essentially of polyurethane, silicone or vinyl.

15. A method of sealing a seam of or patching a garment, using a garment patch or tape as recited in claim 1, comprising:
(a) applying the tape or patch to a first surface of the garment to cover a seam or discontinuity in the garment; and
(b) using a laundry press or iron, applying heat to a second surface of the garment, opposite the first surface, sufficient to thermoset the adhesive, so that the adhesive flows into the garment, but not past the film, to form a substantially waterproof bond at the seam or discontinuity.

16. A method as recited in claim 15 wherein (a) and (b) are practiced to repair a used surgeon's gown, to seal a seam in the manufacture of a new surgeon's gown, or to seal a seam in or repair a fire fighter's turnout jacket.

17. A method as recited in claim 15 wherein (b) is practiced by subjecting the garment to a temperature of between 270-400 degrees C.

18. A method of sealing a seam of or patching a garment, using a patch or tape as recited in claim 2, comprising:
(a) applying the tape or patch to a first surface of the garment to cover a seam or discontinuity in the garment; and
(b) using a laundry press, iron, or autoclave, applying heat to a second surface of the garment, opposite the first surface, sufficient to thermoset the adhesive but not damage the fabric, so that the adhesive flows into the garment, but not past the film, to form an aesthetic substantially waterproof bond at the seam or discontinuity.

19. A method as recited in claim 18 wherein (a) and (b) are practiced to repair a used surgeon's gown, to seal a seam in the manufacture of a new surgeon's gown, or to seal a seam in or repair a fire fighter's turnout jacket.

20. A method as recited in claim 18 wherein (b) is practiced by subjecting the garment to a temperature of between 270-400 degrees C.

21. A garment made according to the method of claim 15, wherein the sealed seam or repair maintains integrity through at last one hundred autoclave cycles.

22. A garment made according to the method of claim 18, wherein the sealed seam or repair maintains integrity through at last one hundred autoclave/wash/dry cycles.

23. A garment made according to the method of claim 14 and passing ASTM D751, ISO 811, ASTM F1670, and ASTM F1671.
